(19) United States
(12) Patent Application Publication
(10) Pub. No.: US 2025/0363673 A1
(43) Pub. Date: Nov. 27, 2025

(54) METHOD AND APPARATUS FOR VOLUMETRIC REPRESENTATION NEURAL NETWORK ENCODING/DECODING

(71) Applicant: Electronics and Telecommunications Research Institute, Daejeon (KR)

(72) Inventors: Jun Sik KIM, Daejeon (KR); Gun BANG, Daejeon (KR); Soo Woong KIM, Daejeon (KR); Ji Hoon DO, Daejeon (KR); Seong Jun BAE, Daejeon (KR); Ha Hyun LEE, Daejeon (KR); Jung Won KANG, Daejeon (KR); Jin Soo CHOI, Daejeon (KR); Je Won KANG, Seoul (KR); Ju Yeon SHIN, Seoul (KR)

(73) Assignee: Electronics and Telecommunications Research Institute, Daejeon (KR)

(21) Appl. No.: 19/214,648

(22) Filed: May 21, 2025

(30) Foreign Application Priority Data
May 23, 2024 (KR) 10-2024-0067370
May 20, 2025 (KR) 10-2025-0065531

(51) Int. Cl. G06T 9/00; H04N 19/597

(52) U.S. Cl. CPC G06T 9/002; H04N 19/597

(57) ABSTRACT

The present disclosure relates to a method and apparatus for volumetric representation neural network coding/decoding. A method for encoding a volumetric representation neural network according to one aspect of the present disclosure may include: generating one or more multi-view image sets by grouping a plurality of multi-view images; generating one or more volumetric representation neural networks expressing three-dimensional characteristics of the one or more multi-view image sets; generating features capable of reconstructing the one or more volumetric representation neural networks from the one or more volumetric representation neural networks; and encoding the features to generate a bitstream.

### CROSS-REFERENCE TO RELATED APPLICATIONS

This application claims the benefit of earlier filing date and right of priority to Korean Application No. 10-2024-0067370, filed on May 23, 2024, Korean Application No. 10-2025-0065531, filed on May 20, 2025, the contents of which are all hereby incorporated by reference herein in their entirety.

### TECHNICAL FIELD

The present disclosure relates to a method for encoding/decoding a volumetric representation neural network, and more particularly, to a method and apparatus for encoding/decoding a volumetric representation neural network generated from a multi-view image.

### BACKGROUND

Recently, volumetric representation neural network technology that converts multi-point images acquired from real space into neural networks to restore arbitrary virtual viewpoints is rapidly developing.

Virtual viewpoints generated based on existing signal processing technologies have the problem of quality degradation due to artifacts that occur when high-frequency components of objects are lost, but volumetric representation neural networks have the advantage of generating fewer artifacts by generating virtual high-frequency components when generating virtual viewpoints. In particular, since they use pre-trained models, high-quality virtual viewpoints can be generated quickly. Therefore, if pre-trained volumetric representation neural networks are transmitted instead of images when transmitting multi-point images, users can reproduce high-quality images from various viewpoints.

However, since transmitting neural network data as is requires a large cost compared to transmitting encoded images, a high-efficiency neural network encoding/decoding technology suitable for volumetric representation neural networks is required.

### SUMMARY

The volumetric representation neural network acquired through the multi-view image is compressed by applying a lightweight technique such as quantization and pruning and then performing arithmetic encoding, or by generating a decomposed feature in the form of a two-dimensional plane or one-dimensional vector using a tensor decomposition technique such as CANDECOMP and PARAFAC, and then compressed using an existing video codec. It has been confirmed that this compression method can achieve effective compression for the volumetric representation neural network, however it is difficult to maintain spatial or temporal consistency because it does not consider the spatiotemporal changes of the input multi-view image when compressing the volumetric representation neural network. When the spatiotemporal consistency is disrupted when the user consumes a replay video, not only is the immersion of the video reduced, but problems such as feeling dizzy also occur. Therefore, in order to commercialize a replay video based on a volumetric representation neural network, an efficient compression method of a volumetric neural network that can maintain spatiotemporal consistency is essential.

A technical object of the present disclosure is to provide a method and an apparatus for encoding/decoding a volumetric representation neural network generated from a re-view image.

The technical objects to be achieved by the present disclosure are not limited to the above-described technical objects, and other technical objects which are not described herein will be clearly understood by those skilled in the pertinent art from the following description.

A method for encoding a volumetric representation neural network according to one aspect of the present disclosure may include: generating one or more multi-view image sets by grouping a plurality of multi-view images; generating one or more volumetric representation neural networks expressing three-dimensional characteristics of the one or more multi-view image sets; generating features capable of reconstructing the one or more volumetric representation neural networks from the one or more volumetric representation neural networks; and encoding the features to generate a bitstream.

An apparatus for encoding a volumetric representation neural network according to an additional aspect of the present disclosure may include: at least one processor; and at least one memory operably connected to the at least one processor and storing instructions that, when executed by the one or more processors, cause the apparatus to perform operations. The operations may include: generating one or more multi-view image sets by grouping a plurality of multi-view images; generating one or more volumetric representation neural networks expressing three-dimensional characteristics of the one or more multi-view image sets; generating features capable of reconstructing the one or more volumetric representation neural networks from the one or more volumetric representation neural networks; and encoding the features to generate a bitstream.

At least one non-transitory computer-readable medium storing at least one instruction according to an additional aspect of the present invention, wherein the at least one instruction executable by at least one processor may control an apparatus for encoding a volumetric representation neural network to: generate one or more multi-view image sets by grouping a plurality of multi-view images; generate one or more volumetric representation neural networks expressing three-dimensional characteristics of the one or more multi-view image sets; generate features capable of reconstructing the one or more volumetric representation neural networks from the one or more volumetric representation neural networks; and encode the features to generate a bitstream.

Preferably, the one or more multi-view image sets may be generated from all or part of the multi-view images of a single time point.

Preferably, the one or more volumetric representation neural networks may be generated by applying one of an implicit method, an explicit method, and a hybrid method in expressing the three-dimensional characteristics.

Preferably, the features may include at least one of one or more one-dimensional vectors, one or more two-dimensional planes, and one or more coefficients used as inputs of the one or more volumetric representation neural networks.

Preferably, the third apparatus may perform a function of orchestrating management for multiple layers.

Preferably, the encoding the features to generate the bitstream may comprise: grouping the features into encoding units to generate one or more feature groups; determining a feature type of each feature by performing feature relearning on features in the one or more feature groups; performing prediction on the features based on the feature type of each feature to generate predicted features; and encoding the features and the predicted features to generate the bitstream.

Preferably, at least one of the one or more feature groups may be generated by grouping a feature derived from a volumetric representation neural network with a feature derived from a volumetric representation neural network of a different time point or different spatial point.

Preferably, the feature relearning may be performed on two or more adjacent features in a feature group or on two or more features in adjacent feature groups.

Preferably, the feature type may include an I feature having no reference feature, a P feature having one reference feature, and two or more B features having reference features.

Preferably, the prediction may be performed differently based on whether each of the features is a one-dimensional vector, a two-dimensional plane, or a coefficient used as an input of the volumetric representation neural network.

According to an embodiment of the present invention, compression efficiency can be improved by generating a volumetric representation neural network capable of maintaining spatiotemporal consistency, generating features from the generated volumetric representation neural network, and effectively encoding the features.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a method for encoding a volumetric representation neural network according to an embodiment of the present invention.

FIG. 2 illustrates a multi-view image according to an embodiment of the present invention.

FIG. 3 illustrates a method for generating of a multi-view image set according to an embodiment of the present invention.

FIG. 4 illustrates a method for generating of a volumetric representation neural network using a Gaussian splatting technique according to an embodiment of the present invention.

FIG. 5 illustrates decomposition of a volumetric representation neural network and generation of features according to an embodiment of the present invention.

FIG. 6 illustrates a method for encoding features according to an embodiment of the present invention.

FIG. 7 illustrates a method for generating a feature group according to an embodiment of the present invention.

FIG. 8 illustrates a method for generating a feature group according to an embodiment of the present invention.

FIG. 9 illustrates relearning of features according to an embodiment of the present invention.

FIG. 10 illustrates a method for determining a feature type according to an embodiment of the present invention.

FIG. 11 illustrates a prediction method based on feature characteristics according to one embodiment of the present invention.

FIG. 12 illustrates a prediction method based on feature characteristics according to one embodiment of the present invention.

FIG. 13 illustrates a decoding method of a volumetric representation neural network according to one embodiment of the present invention.

FIG. 14 illustrates a method for encoding a volumetric representation neural network according to one embodiment of the present invention.

FIG. 15 is a block diagram of an apparatus for encoding a volumetric representation neural network according to one embodiment of the present invention.

### DETAILED DESCRIPTION

Since the present disclosure can make various changes and have various embodiments, specific embodiments will be illustrated in the drawings and described in detail in the detailed description. However, this is not intended to limit the present disclosure to specific embodiments, and should be understood to include all changes, equivalents, and substitutes included in the feature and technical scope of the present disclosure. Similar reference numbers in the drawings refer to identical or similar functions across various aspects. The shapes and sizes of elements in the drawings may be exaggerated for clearer explanation. For a detailed description of the exemplary embodiments described below, refer to the accompanying drawings, which illustrate specific embodiments by way of example. These embodiments are described in sufficient detail to enable those skilled in the art to practice the embodiments. It should be understood that the various embodiments are different from one another but are not necessarily mutually exclusive. For example, specific shapes, structures and characteristics described herein with respect to one embodiment may be implemented in other embodiments without departing from the spirit and scope of the disclosure. Additionally, it should be understood that the position or arrangement of individual components within each disclosed embodiment may be changed without departing from the spirit and scope of the embodiment. Accordingly, the detailed description that follows is not to be intended in a limiting sense, and the scope of the exemplary embodiments is limited only by the appended claims, together with all equivalents to what those claims assert if properly described.

In the present disclosure, terms such as first, second, etc. may be used to describe various components, but the components should not be limited by the terms. The above terms are used only for the purpose of distinguishing one component from another. For example, a first component may be referred to as a second component, and similarly, the second component may be referred to as a first component without departing from the scope of the present disclosure. The term “and/or” includes any of a plurality of related stated items or a combination of a plurality of related stated items.

When a component of the present disclosure is referred to as being “connected” or “accessed” to another component, it may be directly connected or connected to the other component, but other components may exist in between. It must be understood that it may be possible. On the other hand, when it is mentioned that a component is “directly connected” or “directly accessed” to another component, it should be understood that there are no other components in between.

The components appearing in the embodiments of the present disclosure are shown independently to represent different characteristic functions, and do not mean that each component is comprised of separate hardware or one software component. That is, each component is listed and included as a separate component for convenience of explanation, and at least two of each component can be combined to form one component, or one component can be divided into a plurality of components to perform a function, and each of these components can be divided into a plurality of components. Integrated embodiments and separate embodiments of the constituent parts are also included in the scope of the present disclosure as long as they do not deviate from the essence of the present disclosure.

The terms used in this disclosure are only used to describe specific embodiments and are not intended to limit the disclosure. Singular expressions include plural expressions unless the context clearly dictates otherwise. In the present disclosure, terms such as “comprise” or “have” are intended to designate the presence of features, numbers, steps, operations, components, parts, or combinations thereof described in the specification, but are not intended to indicate the presence of one or more other features. It should be understood that this does not exclude in advance the possibility of the existence or addition of elements, numbers, steps, operations, components, parts, or combinations thereof. In other words, the description of “including” a specific configuration in this disclosure does not exclude configurations other than the configuration, and means that additional configurations may be included in the scope of the implementation of the disclosure or the technical feature of the disclosure.

Some of the components of the present disclosure may not be essential components that perform essential functions in the present disclosure, but may simply be optional components to improve performance. The present disclosure can be implemented by including only essential components for implementing the essence of the present disclosure, excluding components used only to improve performance, and a structure that includes only essential components excluding optional components used only to improve performance is also included in the scope of rights of this disclosure.

Hereinafter, embodiments of the present disclosure will be described in detail with reference to the drawings. In describing the embodiments of the present specification, if it is determined that a detailed description of a related known configuration or function may obscure the gist of the present specification, the detailed description will be omitted, and the same reference numerals will be used for the same components in the drawings. Redundant descriptions of the same components are omitted.

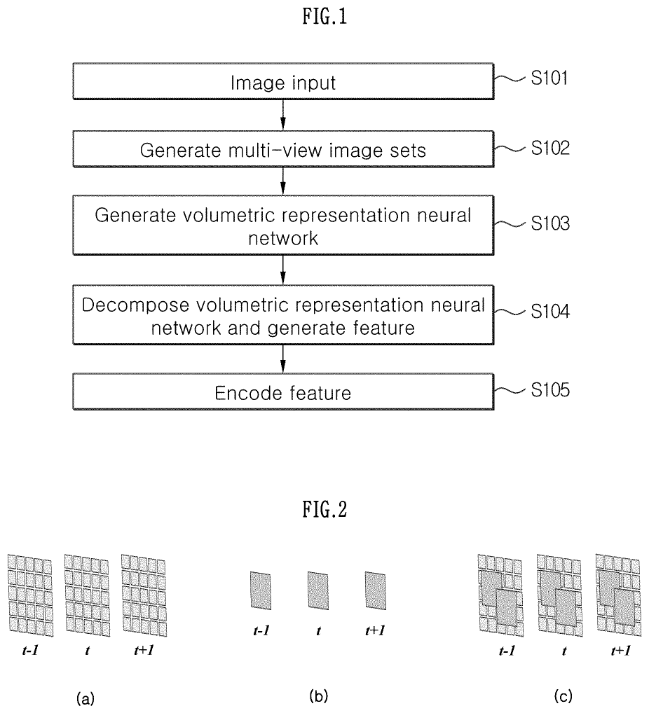

FIG. 1 illustrates a method for encoding a volumetric representation neural network according to an embodiment of the present invention.

Referring to FIG. 1, an encoding device receives one or more images (S101).

Here, when the encoding device performs encoding/decoding on the input images, the input images can be defined as follows, and this will be described in more detail with reference to FIG. 2.

FIG. 2 illustrates a multi-view image according to an embodiment of the present invention.

In FIG. 2, t−1, t, and t+1 represent specific points in time in predetermined time units.

For example, as shown in FIG. 2(a), the encoding device can receive as input one or more multi-view images captured by multiple cameras from various angles. For example, the camera array can include a spherical array of multi-view cameras, a light field camera, etc. However, these examples are for convenience of explanation, and the present invention is not limited thereto, and multi-view images simultaneously acquired from more diverse camera arrays can be used.

As another example, as shown in FIG. 2(b), the encoding device can receive as input one or more images captured by one camera. Here, for example, the camera can include various lens cameras such as spherical, fish-eye, and wide-angle, fish-eye lens cameras, lenslet cameras, front-facing cameras, etc. However, these examples are for convenience of explanation, and the present invention is not limited thereto, and single-view images acquired from more diverse cameras can be used.

As another example, as shown in FIG. 2(c), the encoding device can simultaneously receive and use one or more multi-view images and one or more single-view images as inputs.

Referring again to FIG. 1, the encoding device generates one or more multi-view image sets (MVs) from one or more input images (S102).

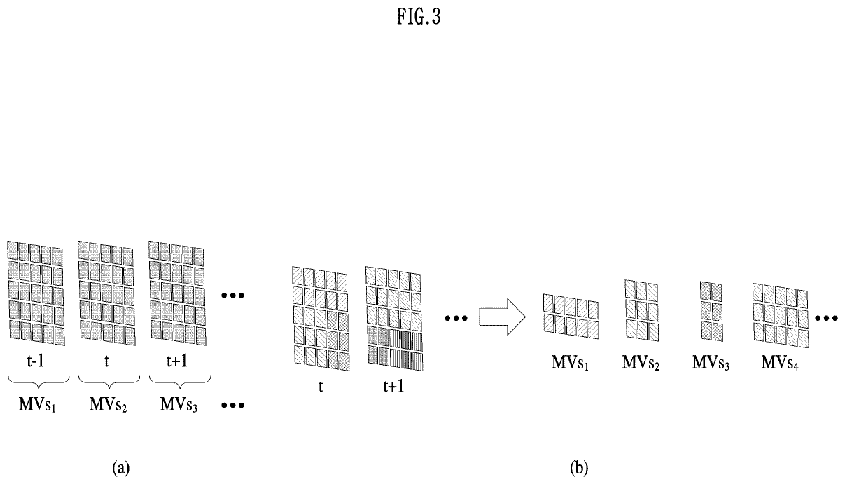

Here, the encoding device can generate one or more multi-view image sets to be encoded from one or more input images, which will be described in more detail with reference to FIG. 3.

FIG. 3 illustrates a method for generating of a multi-view image set according to an embodiment of the present invention.

In FIG. 3, t−1, t, and t+1 represent specific points in time in predetermined time units, and MVs represent a set of multi-point images.

For example, as in FIG. 3(a), the encoding device can configure multi-view images existing at a single time point in time into a single multi-view image set.

As another example, as shown in FIG. 3(b), the encoding device can construct multiple multi-view image sets from multi-view images of a single time point in time. As shown in FIG. 3(b), MVs1, MVs2, and MVs3 can be constructed from multi-view images of time point in time t, and MVs4, etc. can be constructed from multi-view images of time point in time t+1.

Referring again to FIG. 1, the encoding device generates a volumetric representation neural network from the multi-view image set (S103).

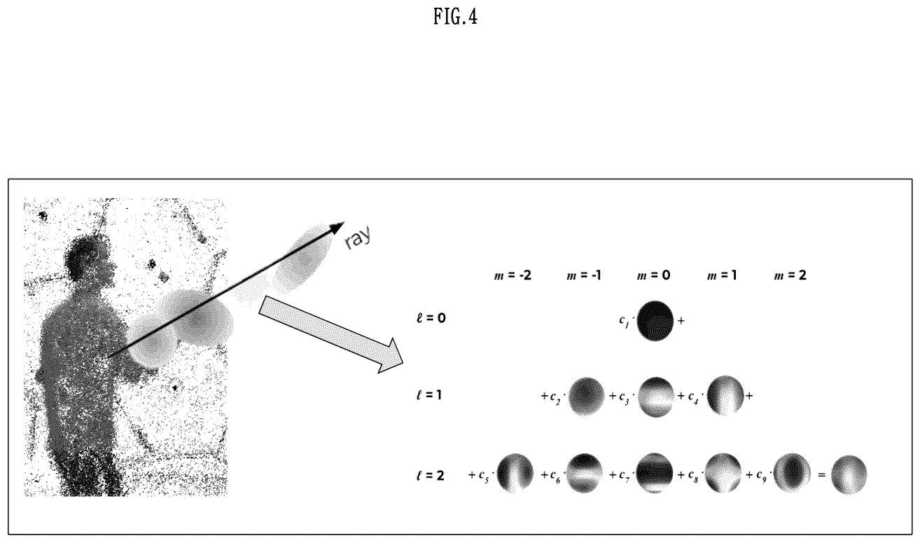

Here, the encoding device can generate a volumetric representation neural network from one or more multi-view image sets generated in the previous step, which is described in more detail with reference to FIG. 4. Here, it can be referred to as learning a method of generating a volumetric representation.

FIG. 4 illustrates a method for generating of a volumetric representation neural network using a Gaussian splatting technique according to an embodiment of the present invention.

For example, the encoder can learn a neural network that implicitly represents the three-dimensional characteristics of multi-view image sets using techniques such as neural radiance fields (NeRFs). Here, implicit representation means that the neural network that has learned the volumetric representation does not have the geometric structure of the target space to be represented.

As another example, the encoding device can learn a neural network that inputs and outputs coefficients that explicitly express the three-dimensional characteristics of multi-view image sets through techniques such as three-dimensional (3D) Gaussian splatting, as shown in FIG. 4. Here, the explicit expression means coefficients of a volumetric representation structure learned through the neural network.

Referring to FIG. 4, I represents a degree, I=0 means omnidirectionality, I=1 means linear directivity, and I=2 represents a complex directivity of a quadratic surface shape. M represents various components of the mode and directional axis within each degree. The spheres illustrated in FIG. 4 visualize spherical harmonic basis functions corresponding to specific I, m values, and c1, . . . , c9 represent coefficients of the corresponding components. That is, FIG. 4 conceptually illustrates expressing information that varies depending on direction (e.g., illumination, reflection, etc.) as spherical harmonics components.

As another example, the encoding device can learn a neural network representing the 3D characteristics of the multi-view image set by using a hybrid neural representation method that applies both the implicit and explicit representation methods described above.

As another example, the encoding device can learn by considering neural network values derived from adjacent multi-view image sets in learning the volumetric representation neural network to increase encoding efficiency between multi-view image sets.

The encoding device can perform learning using at least one of the above-described methods. That is, the encoding device can generate a volumetric representation neural network from one or more multi-view image sets using at least one of the above-described methods.

The above-described methods for generating a volumetric representation neural network are examples, and the present invention is not limited thereto.

Referring again to FIG. 1, the encoding device decomposes the volumetric representation neural network and generates one or more features (S104).

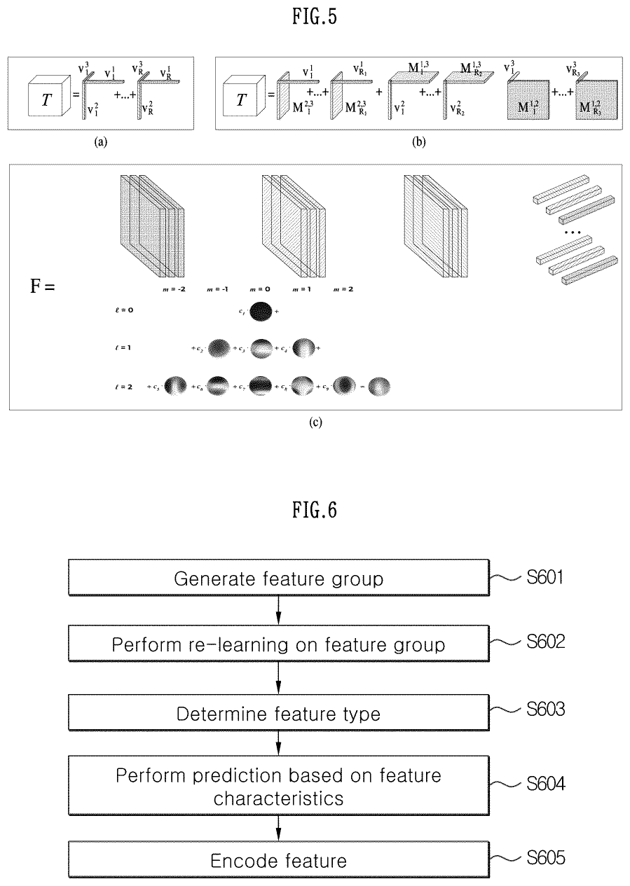

Here, the encoding device can decompose the volumetric representation neural network generated in the previous step to generate features that can reconstruct the neural network, which will be described in more detail with reference to FIG. 5.

FIG. 5 illustrates decomposition of a volumetric representation neural network and generation of features according to an embodiment of the present invention.

For example, as shown in FIG. 5(a), the encoding device can decompose the volumetric representation neural network into a plurality of one-dimensional vectors using a technique such as CP (CANDECOMP/PARAFAC) decomposition. v_{R}¹, v_{R}², and v_{R}³ in FIG. 5(a) illustrate a one-dimensional vector for the first axis (e.g., x-axis), a two-dimensional vector for the second axis (e.g., y-axis), and a one-dimensional vector for the third axis (e.g., z-axis), respectively.

As another example, as shown in FIG. 5(b), the encoding device can decompose the volumetric representation neural network into a plurality of two-dimensional planes and one-dimensional vectors using a technique such as vector-matrix decomposition. v_{R1}¹, v_{R2}² and v_{R3}³ in FIG. 5(b) illustrate a one-dimensional vector for the first axis (e.g., the x-axis), a one-dimensional vector for the second axis (e.g., the y-axis), and a one-dimensional vector for the third axis (e.g., the z-axis), respectively. In addition, M_{R1}^{2,3}, MR₂^{1,3}, and M_{R3}^{1,2} in FIG. 5(b) illustrate a two-dimensional plane formed by the second axis and the third axis, a two-dimensional plane formed by the first axis and the third axis, and a two-dimensional plane formed by the first axis and the second axis, respectively.

Each position of the above-described one-dimensional vector and two-dimensional vector can be composed of one or more coefficients.

In this specification, the coefficients (such as 3D Gaussian coefficients) utilized as additional inputs of the plane, vector, and volumetric representation neural network capable of reconstructing the above-described volumetric representation neural network are collectively referred to as features.

Referring again to FIG. 1, the encoding device compresses/encodes one or more features (S105).

Hereinafter, the feature encoding method of step S105 will be described in detail with reference to FIG. 6.

FIG. 6 illustrates a method for encoding features according to an embodiment of the present invention.

Referring to FIG. 6, the encoding device generates a feature group (S601).

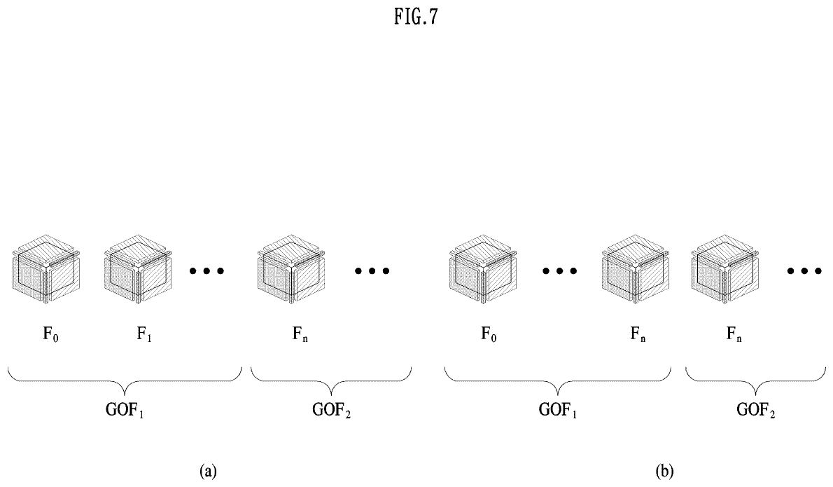

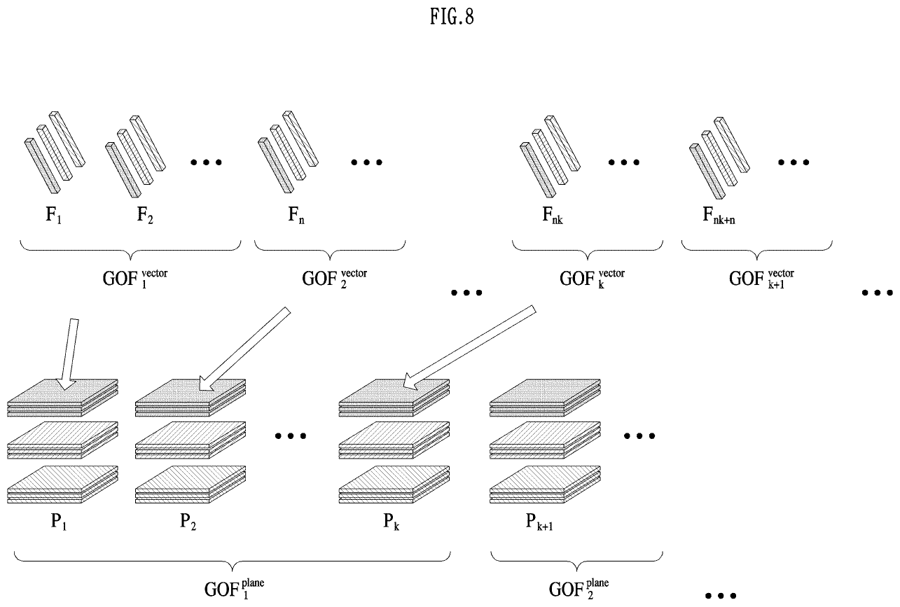

Here, when the encoding device performs feature encoding, features generated through a plurality of volumetric representation neural networks can be grouped into one encoding unit to generate a feature group (GOF: Group of Features), and this will be described in more detail with reference to FIG. 7 and FIG. 8.

FIG. 7 and FIG. 8 illustrate a method for generating a feature group according to an embodiment of the present invention.

In FIG. 7 and FIG. 8, F₀, F₁, . . . , Fₙ and Fₙₖ, . . . , Fₙₖ₊ₙ represent features (e.g., one-dimensional vectors and/or two-dimensional vectors) generated by decomposing a volumetric representation neural network, respectively.

As shown in FIG. 7(a), the encoding device can group features derived through one volumetric representation neural network with features derived through one volumetric representation neural network of other time points or other spatial points to construct feature groups. FIG. 7(a) illustrates those multiple features such as F₀, F₁, . . . are grouped into GOF₁, and multiple features such as Fₙ, . . . are grouped into GOF₂.

For example, a first feature generated by decomposing a volumetric representation neural network generated from a multi-viewpoint image set constructed from multi-viewpoint images of time t and a second feature generated by decomposing a volumetric representation neural network generated from a multi-viewpoint image set constructed from multi-viewpoint images of time t+1 may be grouped. As another example, a first feature generated by decomposing a volumetric representation neural network generated from a first multi-view image set constructed from a portion of multi-view images of time t and a second feature generated by decomposing a volumetric representation neural network generated from a second multi-view image set constructed from a portion of multi-view images of time t may be grouped.

In addition, as shown in FIG. 7(b), different feature groups can share one or more features to improve encoding efficiency or quality of restored images. For example, as shown in the example of FIG. 7(b), both GOF₁ and GOF₂ can commonly include Fₙ.

In addition, as shown in FIG. 8, feature groups can be grouped differently according to the characteristics of the features. For example, a planar feature group can be defined by generating one representative planar feature per vector and coefficient feature group. In this case, features in the vector and coefficient feature groups share one representative planar feature. FIG. 8 exemplifies that features in the GOF₁^{vector group} share the representative planar feature of P₁, features in the GOF₂^{vector group} share the representative planar feature of P₂, and features in the GOFₖ^{vector group} share the representative planar feature of Pₖ.

Referring back to FIG. 6, the encoding device performs re-learning on the feature group (S602).

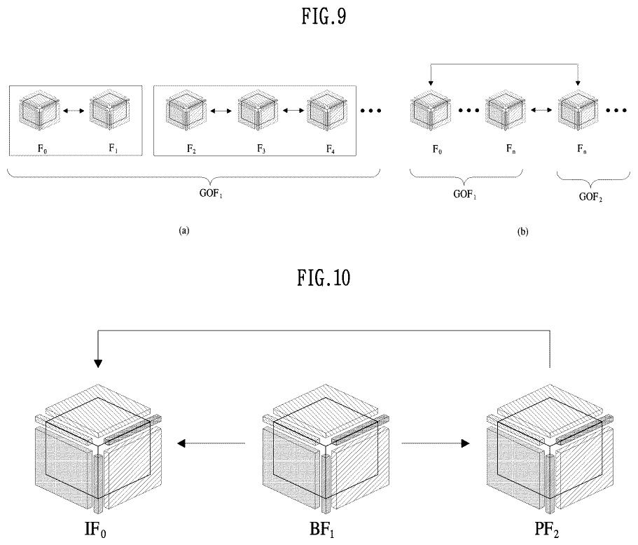

That is, the encoding device can perform re-learning to increase the compression efficiency for the features in the feature group. Here, the re-learning can be performed between features in the feature group or between features in the feature group. Here, the re-learning can mean determining whether there is a reference picture based on the similarity between features, or determining whether there is one or multiple reference pictures if there is a reference picture. This will be described in more detail with reference to FIG. 9.

FIG. 9 illustrates relearning of features according to an embodiment of the present invention.

As shown in FIG. 9(a), feature relearning can be performed on two or more adjacent features within a feature group.

In addition, as shown in FIG. 9(b), feature relearning can be performed on two or more features within an adjacent feature group.

Referring again to FIG. 6, the encoding device determines a feature type (S603).

Here, the encoding device can determine the type of the features within the feature group according to the number of features referenced during encoding. This will be described in more detail with reference to FIG. 10.

FIG. 10 illustrates a method for determining a feature type according to an embodiment of the present invention.

In FIG. 10, the arrows illustrate directions in which the current feature refers to the reference feature.

Referring to FIG. 10, the encoding device can designate a feature without a reference feature (i.e., a feature that does not refer to any feature) such as IF₀ of FIG. 10 as an I feature. In addition, the encoding device can designate a feature with one reference feature such as PF₂ of FIG. 10 as a P feature. In addition, the encoding device can designate a feature with two or more reference features such as BF₁ of FIG. 10 as a B feature.

Referring again to FIG. 6, the encoding device can perform prediction based on feature characteristics (S604).

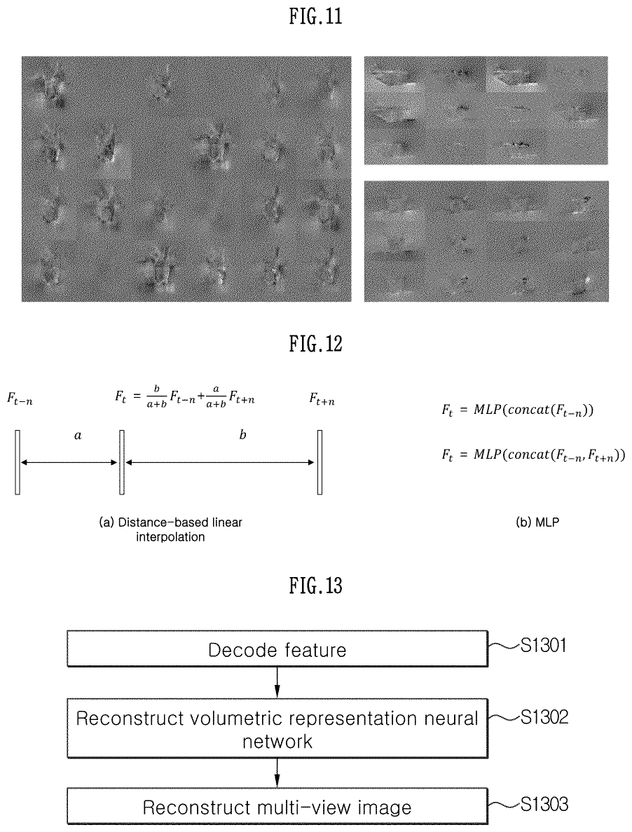

As described above, features can be composed of coefficients that are utilized as additional inputs of planar, vector, and volumetric representation neural networks, and the encoding device can make different predictions depending on the characteristics of these features. This will be described in more detail with reference to FIG. 11 and FIG. 12.

FIG. 11 and FIG. 12 illustrate a prediction method based on feature characteristics according to one embodiment of the present invention.
i) For example, features can be quantized to be efficient for compression according to their characteristics (plane, vector, coefficient).
ii) In addition, for example, as in FIG. 11, planar features can be packed into a 2D grid and then compressed through an existing video codec (VVC, HEVC, etc.). Here, the encoding device can determine the compression mode of the video codec according to the type of feature (I feature, P feature, B feature) during compression.
iii) In addition, for example, vector features can be compressed via NNC (Neural Network Compression). Here, the encoding device can use NNC or INNC (Incremental NNC) depending on the reference structure of the type of feature (I feature, P feature, B feature) during compression.
iv) In addition, for example, referring to FIG. 12, the encoding device can predict that P and B type features are generated through I type features. Here, the P type feature can be generated by using the I type feature as it is, or by using prediction and compensation techniques such as MLP (Multi Layer Perceptron) or differences from reference features, alone or in combination. In addition, the B type feature can be generated by predicting and compensating for two or more features. For prediction and compensation of the B type feature, prediction and compensation techniques such as MLP (Multi Layer Perceptron), distance-based linear interpolation (LI), and differences from reference feature(s) can be used alone or in combination.

The above-described characteristic-based prediction methods of i), ii), iii), and iv) can be used alone or in combination of multiple methods depending on the characteristics of the feature.

That is, the encoding device can perform the above-described prediction to generate a predicted feature. For example, such a predicted feature can be used to generate a restored feature/signal or to generate a residual feature/signal.

Referring again to FIG. 6, the encoding device performs encoding/compressing of the feature (S605).

That is, the above original features and predicted features can be compressed/encoded through an arithmetic coding (i.e., entropy coding) technique, and can be configured as a bitstream by being contained in a container composed of parameters required for decoding.

For example, a transform coefficient can be generated by applying a transform technique to a residual feature/signal, and the transform coefficients can be compressed/encoded through an arithmetic coding technique after being quantized.

And, the encoding device can provide/transmit the bitstream to an image decoding device, or store it in a recording medium, etc.

FIG. 13 illustrates a decoding method of a volumetric representation neural network according to one embodiment of the present invention.

Referring to FIG. 13, the decoding device decodes a feature from a bitstream generated by the encoding device (S1301).

Here, the process of decoding the feature can be performed in the reverse order of the feature encoding process exemplified in FIG. 6 above.

That is, the decoding device decodes a feature from the bitstream (i.e., acquires an original feature), and prediction based on feature characteristics can be performed. In addition, the image decoding device can determine a feature type, relearn a feature group, and generate a feature group.

The decoding device reconstructs a volumetric representation neural network (S1302).

That is, the decoding device can decode the encoded features and reconstruct the volumetric representation neural network.

The decoding device reconstructs the multi-view images (S1303).

That is, the decoding device can restore multi-view images by receiving location information, viewpoint information, etc. for the reconstructed volumetric representation neural network.

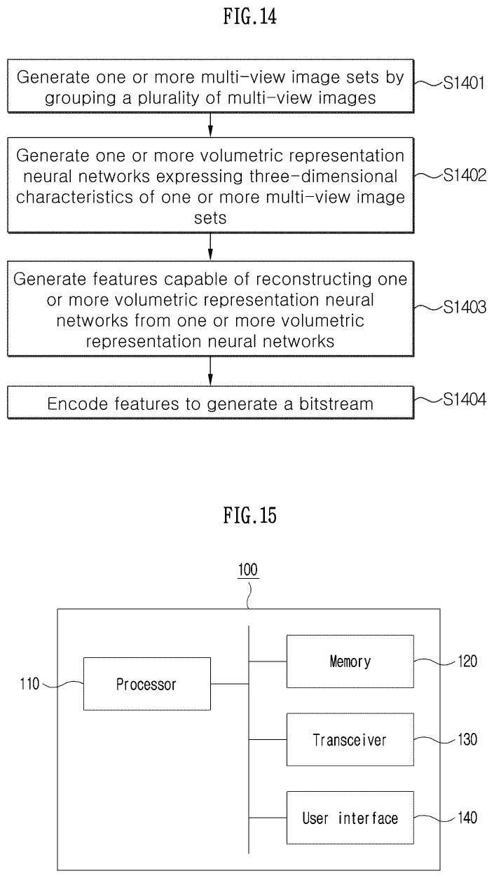

FIG. 14 illustrates a method for encoding a volumetric representation neural network according to one embodiment of the present invention.

Referring to FIG. 14, the device generates one or more multi-view image sets by grouping a plurality of multi-view images (S1401).

Here, the one or more multi-view image sets can be generated from all or part of the multi-view images of a single time point.

The device generates one or more volumetric representation neural networks expressing three-dimensional characteristics of the one or more multi-view image sets (S1402).

Here, the one or more volumetric representation neural networks can be generated by applying one of an implicit method, an explicit method, and a hybrid method in expressing the three-dimensional characteristics.

The device generates features capable of reconstructing the one or more volumetric representation neural networks from the one or more volumetric representation neural networks (S1403).

Here, the features may include at least one of one of one or more one-dimensional vectors, one or more two-dimensional planes, and one or more coefficients used as inputs of the one or more volumetric representation neural networks.

The device encodes the features to generate a bitstream (S1404).

The step of encoding the features to generate the bitstream may include: grouping the features into encoding units to generate one or more feature groups, determining a feature type of each feature by performing feature relearning on features in the one or more feature groups, performing prediction on the features based on the feature type of each feature to generate predicted features, and encoding the features and the predicted features to generate the bitstream.

Here, at least one of one or more feature groups can be generated by grouping a feature derived from a volumetric representation neural network with a feature derived from a volumetric representation neural network of a different time point or different spatial point.

In addition, the feature re-learning can be performed on two or more adjacent features in a feature group or on two or more features in adjacent feature groups.

In addition, the feature type may include an I feature having no reference feature, a P feature having one reference feature, and two or more B features having reference features.

In addition, the prediction may be performed differently based on whether each of the features is a one-dimensional vector, a two-dimensional plane, or a coefficient used as an input of the volumetric representation neural network.

FIG. 15 is a block diagram of an apparatus for encoding a volumetric representation neural network according to one embodiment of the present invention.

The apparatus 100 may include one or more processors 110, one or more memories 120, one or more transceivers 130, and one or more user interfaces 140. The memory 120 may be included in the processor 110 or may be configured separately. The memory 120 may store instructions that, when executed by the processor 110, cause the apparatus 100 to perform an operation. The transceiver 130 may transmit and/or receive signals and data that the apparatus 100 exchanges with other entities. The user interface 140 may receive a user's input regarding the first apparatus 100 or provide an output of the apparatus 100 to the user. Among the components of the apparatus 100, components other than the processor 110 and the memory 120 may not be included in some cases, and other components not shown in FIG. 15 may be included in the apparatus 100.

The processor 110 may be configured to enable the above-described apparatus 100 to perform methods according to various examples of the present disclosure. Although not shown in FIG. 15, the processor 110 may be configured as a set of modules that perform each method/function proposed in this disclosure. Modules may be configured in hardware and/or software form.

The processor 110 generates one or more multi-view image sets by grouping a plurality of multi-view images.

Here, the one or more multi-view image sets can be generated from all or part of the multi-view images of a single time point.

The processor 110 generates one or more volumetric representation neural networks expressing three-dimensional characteristics of the one or more multi-view image sets.

Here, the one or more volumetric representation neural networks can be generated by applying one of an implicit method, an explicit method, and a hybrid method in expressing the three-dimensional characteristics.

The processor 110 generates features capable of reconstructing the one or more volumetric representation neural networks from the one or more volumetric representation neural networks.

Here, the features may include at least one of one of one or more one-dimensional vectors, one or more two-dimensional planes, and one or more coefficients used as inputs of the one or more volumetric representation neural networks.

The processor 110 encodes the features to generate a bitstream.

The step of encoding the features to generate the bitstream may include: grouping the features into encoding units to generate one or more feature groups, determining a feature type of each feature by performing feature relearning on features in the one or more feature groups, performing prediction on the features based on the feature type of each feature to generate predicted features, and encoding the features and the predicted features to generate the bitstream.

Here, at least one of one or more feature groups can be generated by grouping a feature derived from a volumetric representation neural network with a feature derived from a volumetric representation neural network of a different time point or different spatial point.

In addition, the feature re-learning can be performed on two or more adjacent features in a feature group or on two or more features in adjacent feature groups.

In addition, the feature type may include an I feature having no reference feature, a P feature having one reference feature, and two or more B features having reference features.

In addition, the prediction may be performed differently based on whether each of the features is a one-dimensional vector, a two-dimensional plane, or a coefficient used as an input of the volumetric representation neural network.

Components described in exemplary embodiments of the present disclosure may be implemented by hardware elements. For example, the hardware element may include at least one of a digital signal processor (DSP), a processor, a controller, an application specific integrated circuit (ASIC), a programmable logic element such as an FPGA, a GPU, other electronic devices, or a combination thereof. At least some of the functions or processes described in the exemplary embodiments of the present disclosure may be implemented as software, and the software may be recorded on a recording medium. Components, functions, and processes described in exemplary embodiments may be implemented in a combination of hardware and software.

The method according to an embodiment of the present disclosure may be implemented as a program that can be executed by a computer, and the computer program may be recorded in various recording media such as magnetic storage media, optical read media, and digital storage media.

The various technologies described in this disclosure may be implemented as digital electronic circuits or computer hardware, firmware, software, or a combination thereof. The above technologies may be implemented as a computer program product, that is, a computer program tangibly embodied in an information medium (e.g., a machine-readable storage device (e.g., a computer-readable medium) or a data processing device) or a computer program implemented as signals processed by or propagated by a data processing device to cause the operation of the data processing device (e.g., programmable processor, computer, or multiple computers).

Computer program(s) may be written in any form of programming language, including compiled or interpreted languages and may be distributed as a stand-alone program or in any form, including modules, components, subroutines, or other units suitable for use in a computing environment. A computer program may be executed by a single computer or by multiple computers distributed at one site or multiple sites and interconnected by a communications network.

Examples of processors suitable for executing computer programs include general-purpose and special-purpose microprocessors, and one or more processors in digital computers. Typically, a processor receives instructions and data from read-only memory, random access memory, or both. Components of a computer may include at least one processor for executing instructions and one or more memory devices for storing instructions and data. Additionally, the computer may include one or more mass storage devices for data storage, such as magnetic, magneto-optical disks, or optical disks, or may be connected to the mass storage devices to receive and/or transmit data. Examples of information media suitable for implementing computer program instructions and data include optical media such as semiconductor memory devices (e.g., magnetic media such as hard disks, floppy disks, and magnetic tapes), compact disk read-only memory (CD-ROM), digital video disk (DVD), etc., magneto-optical media such as floptical disks, and read only memory (ROM), random access memory (RAM), flash memory, erasable programmable ROM (EPROM), electrically erasable programmable ROM (EEPROM), and other known computer-readable media. Processors and memories can be supplemented or integrated by special-purpose logic circuits.

A processor may run an operating system (OS) and one or more software applications that run on the OS. The processor device may also access, store, manipulate, process and generate data in response to software execution. For simplicity, the processor device is described in the singular, but those skilled in the art will understand that the processor device may include a plurality of processing elements and/or various types of processing elements. For example, a processor device may include a plurality of processors or a processor and a controller. Additionally, different processing structures, such as parallel processors, may be configured. Additionally, computer-readable media refers to all media that a computer can access, and may include both computer storage media and transmission media.

Although this disclosure includes detailed descriptions of various detailed implementation examples, the details should not be construed as limiting the invention or scope of the claims proposed in this disclosure, but rather illustrating features of specific exemplary embodiments.

Features individually described in exemplary embodiments in this disclosure may be implemented by a single exemplary embodiment. Conversely, various features described in this disclosure with respect to a single exemplary embodiment may be implemented by a combination or appropriate sub-combination of a plurality of exemplary embodiments. Furthermore, in the present disclosure, the features may operate by a specific combination, and the combination may initially be described as claimed, however, in some cases, one or more features may be excluded from the claimed combination, or claimed combinations may be modified in the form of sub-combinations or modifications of sub-combinations.

Similarly, even if operations are depicted in a specific order in the drawings, it should not be understood that execution of the operations in a specific order or sequence is necessary, or that performance of all operations is required to obtain a desired result. In certain cases, multitasking and parallel processing can be useful. Additionally, it should not be understood that the various device components in all exemplary embodiments are necessarily separate, and the above-described program components and devices may be packaged in a single software product or multiple software products.

The exemplary embodiments disclosed herein are illustrative only and are not intended to limit the scope of the disclosure. Those skilled in the art will recognize that various modifications may be made to the exemplary embodiments without departing from the scope of the claims and their equivalents.

Accordingly, this disclosure is intended to include all other substitutions, modifications and changes that fall within the scope of the following claims.

What is claimed is:

1. A method for encoding a volumetric representation neural network, the method comprising:
generating one or more multi-view image sets by grouping a plurality of multi-view images;
generating one or more volumetric representation neural networks expressing three-dimensional characteristics of the one or more multi-view image sets;
generating features capable of reconstructing the one or more volumetric representation neural networks from the one or more volumetric representation neural networks; and
encoding the features to generate a bitstream.

2. The method of claim 1, wherein the one or more multi-view image sets are generated from all or part of the multi-view images of a single time point.

3. The method of claim 1, wherein the one or more volumetric representation neural networks are generated by applying one of an implicit method, an explicit method, and a hybrid method in expressing the three-dimensional characteristics.

4. The method of claim 1, wherein the features include at least one of one or more one-dimensional vectors, one or more two-dimensional planes, and one or more coefficients used as inputs of the one or more volumetric representation neural networks.

5. The method of claim 1, wherein the encoding the features to generate the bitstream comprises:
grouping the features into encoding units to generate one or more feature groups;
determining a feature type of each feature by performing feature relearning on features in the one or more feature groups;
performing prediction on the features based on the feature type of each feature to generate predicted features; and
encoding the features and the predicted features to generate the bitstream.

6. The method of claim 5, wherein at least one of the one or more feature groups is generated by grouping a feature derived from a volumetric representation neural network with a feature derived from a volumetric representation neural network of a different time point or different spatial point.

7. The method of claim 5, wherein the feature relearning is performed on two or more adjacent features in a feature group or on two or more features in adjacent feature groups.

8. The method of claim 5, wherein the feature type includes an I feature having no reference feature, a P feature having one reference feature, and two or more B features having reference features.

9. The method of claim 5, wherein the prediction is performed differently based on whether each of the features is a one-dimensional vector, a two-dimensional plane, or a coefficient used as an input of the volumetric representation neural network.

10. An apparatus for encoding a volumetric representation neural network, the apparatus comprising:
at least one processor; and
at least one memory operably connected to the at least one processor and storing instructions that, when executed by the one or more processors, cause the apparatus to perform operations comprising:
generating one or more multi-view image sets by grouping a plurality of multi-view images;
generating one or more volumetric representation neural networks expressing three-dimensional characteristics of the one or more multi-view image sets;
generating features capable of reconstructing the one or more volumetric representation neural networks from the one or more volumetric representation neural networks; and
encoding the features to generate a bitstream.

11. The apparatus of claim 10, wherein the one or more multi-view image sets are generated from all or part of the multi-view images of a single time point.

12. The apparatus of claim 10, wherein the one or more volumetric representation neural networks are generated by applying one of an implicit method, an explicit method, and a hybrid method in expressing the three-dimensional characteristics.

13. The apparatus of claim 10, wherein the features include at least one of one or more one-dimensional vectors, one or more two-dimensional planes, and one or more coefficients used as inputs of the one or more volumetric representation neural networks.

14. The apparatus of claim 10, wherein the encoding the features to generate the bitstream comprises:
grouping the features into encoding units to generate one or more feature groups;
determining a feature type of each feature by performing feature relearning on features in the one or more feature groups;
performing prediction on the features based on the feature type of each feature to generate predicted features; and
encoding the features and the predicted features to generate the bitstream.

15. The apparatus of claim 14, wherein at least one of the one or more feature groups is generated by grouping a feature derived from a volumetric representation neural network with a feature derived from a volumetric representation neural network of a different time point or different spatial point.

16. The apparatus of claim 14, wherein the feature relearning is performed on two or more adjacent features in a feature group or on two or more features in adjacent feature groups.

17. The apparatus of claim 14, wherein the feature type includes an I feature having no reference feature, a P feature having one reference feature, and two or more B features having reference features.

18. The apparatus of claim 14, wherein the prediction is performed differently based on whether each of the features is a one-dimensional vector, a two-dimensional plane, or a coefficient used as an input of the volumetric representation neural network.

19. At least one non-transitory computer-readable medium storing at least one instruction, wherein the at least one instruction executable by at least one processor controls an apparatus for encoding a volumetric representation neural network to:
generate one or more multi-view image sets by grouping a plurality of multi-view images;
generate one or more volumetric representation neural networks expressing three-dimensional characteristics of the one or more multi-view image sets;
generate features capable of reconstructing the one or more volumetric representation neural networks from the one or more volumetric representation neural networks; and
encode the features to generate a bitstream.
